(19) United States
(12) Patent Application Publication
(10) Pub. No.: US 2008/0267589 A1
(43) Pub. Date: Oct. 30, 2008

(54) TELEVISION BANDWIDTH OPTIMIZATION SYSTEM AND METHOD

(76) Inventors: Gary Turner, Parker, CO (US); Douglas E. McGary, Castle Rock, CO (US)

Correspondence Address: SHERIDAN ROSS PC, 1560 BROADWAY, SUITE 1200, DENVER, CO, 80202, US

(21) Appl. No.: 11/741,046

(22) Filed: Apr. 27, 2007

(51) Int. Cl. H04N 7/26

(52) U.S. Cl. 386/109; 386/E05.007

(57) ABSTRACT

Methods and apparatuses for reducing network bandwidth utilization in TV broadcasting networks are provided. More specifically, the network bandwidth may be reduced by determining that an image will be displayed at smaller than full size on a display apparatus and in response to determining the image will be displayed at a smaller than usual size, reducing the resolution associated with the image. A reduction in the resolution associated with the image results in a reduction of the amount of network bandwidth required to transmit the image across the network.

### FIELD

The present invention is directed to digital image signal processing and more specifically, toward reducing the required amount of bandwidth necessary to transmit broadcast images signals.

### BACKGROUND

Television (TV) has traditionally been used as a one-way communication medium in which the television network decides what programs will be shown at what times. Even with these restrictions TV has proven to be the worlds most popular media delivery device. Much attention has been placed on improving the quality of pictures displayed to a user. With the advent of high-definition TV, more bandwidth is required to transmit a broadcast signal from the broadcast head end to the user's TV.

At best, one cycle of an analog video frequency can provide information to two pixels. A conventional NTSC image has 525 lines scanned at 29.97 Hz with a horizontal resolution of 427 pixels. This gives 3.35 Mbps (assuming two pixels per video cycle) as a minimum bandwidth to carry the video information without compression. Of course, two pixels per video cycle is not always possible, and therefore the typical network bandwidth required to transmit a convention NTSC image is closer to 4 Mbps.

If one decides to move to an HDTV image that is 1050 lines by 600 pixels at the same frame rate, then this means a bandwidth of 18 Mbps is required. This is a problem since the current terrestrial channel allocations are limited to 6 Mbps or 6 MHz. However, certain modulation techniques, such as the 8-level vestigial sideband modulation (VSB) method adopted for terrestrial broadcast of the ATSC digital television standard in the United States, Canada, and other countries allows more than one bit of data to be transmitted per hertz of bandwidth. This 8-VSB modulation standard is generally dedicated to one channel.

The options for terrestrial broadcast of HDTV signals (assuming a 19.2 Mbps bandwidth) are roughly as follows: (1) Change the channel allocation system from 6 Mbps to 19.2. Mbps; (2) Compress the signal to fit inside the 6 Mbps existing bandwidths; or (3) Allocate multiple channels for the HDTV signal. A downside to these options is that they do not allow for multiple video and interactive services to be broadcast on a per channel basis. In other words, traditionally each channel is dedicated to a single video service.

Options (1) and (2) are virtually incompatible with current NTSC service. About the only possibility for maintaining compatibility is simultaneous broadcast of NTSC information over certain channels and HDTV information over other channels. Option (3) does allow compatibility as the first 6 MHz of the signal could keep to the standard NTSC broadcasting and the remaining channels could be additional augmentation signal for HDTV. Unfortunately, increasing the amount of bandwidth requirements for each channel will result in a significant increase in operating costs for TV service providers.

Since, NTSC terrestrial broadcast channels are essentially 6 MHz wide and have a bandwidth of 6 Mbps. Service in a given area is typically offered on every other channel in order to avoid interference effects and a relatively small range of channels are available (channels 2-69, 55-88, 174-216, 470-806 MHz).

TV service providers fall into a number of different categories. Service providers may either be terrestrial, satellite, cable, or combinations thereof. A broadcast TV signal may be transmitted via cables, satellites, and over-air accordingly. As more subscribers begin to migrate to HDTVs, a greater amount of network bandwidth will be required for each channel to support the viewership. Unfortunately, network bandwidth equates directly to costs for TV service providers.

Bandwidth requirements may be further increased as interactive TV (ITV) becomes more prevalent. The technology of ITV has been developed in an attempt to allow a TV set to serve as a two-way information distribution mechanism. Features of an ITV accommodate a variety of marketing, entertainment, and educational capabilities. Typically, the interactive functionality is controlled by a “set-top” decoder box (“set-top box” or “STB”), which executes an interactive program written for the TV broadcast. The interactive functionality is often displayed on the TV's screen and may include icons or menus to allow a user to make selections via the TV's remote control or a keyboard.

The program interactivity may be optional. Thus, a user who chooses not to interact or who does not have interactive functionality included with the user's TV should not suffer any degradation or interruption in program content. In order to provide this option to users, a transparent method of incorporating interactive content into the broadcast stream that carries the program is employed. In the present disclosure, “broadcast stream” or “live broadcast” refers to the broadcast signal, whether analog or digital, regardless of the method of transmission of that signal, i.e. by antenna, satellite, cable, or any other method of analog or digital signal transmission.

One method of transparently incorporating interactive content into the broadcast stream is the insertion of triggers into the broadcast stream for a particular program. The insertion of “triggers” into a broadcast stream is well known in the art. Program content in which such triggers have been inserted is sometimes referred to as enhanced program content or as an enhanced TV program or video signal.

Triggers may be used to alert a STB that interactive content is available. The trigger may contain information about available enhanced content as well as the memory location of the enhanced content. A trigger may also contain user-perceptible text that is displayed on the screen, for example, at the bottom of the screen, which may prompt the user to perform some action or choose amongst a plurality of options. Thus, a user with a TV that has interactive functionality may be prompted at the beginning of an enhanced TV program to choose between interactive and passive (non-interactive) viewing of the enhanced TV program. If the user chooses passive viewing, any further triggers contained in the enhanced TV program may be ignored by the STB and the user will view the program in a conventional way. However, if the user chooses the interactive option, then further triggers may be embedded in the enhanced TV program.

Triggers may be inserted into the broadcast stream at various points along the broadcast path. Triggers may be inserted into the broadcast stream before broadcast of the content by a broadcast station or any other media provider. Thus, these triggers would be part of the broadcast stream received by cable head ends and further distributed to TVs within homes. TVs are provided with interactive functionality by their associated STBs.

One common method for inserting data such as triggers into an analog video signal is the placement of that data into the unused lines of the video signal that make up the vertical blanking interval (VBI). Closed caption text data is a well known example of the placement of data in the VBI of the video signal. The closed caption text data is typically transmitted during line 21 of either the odd or even field of the video frame in a National Television Standards Committee (NTSC) format. Closed caption decoders strip the encoded text data from the video signal, decode the text data, and reformat the data for display, concurrent with the video data, on a TV screen. Such closed caption decoders process the text data separately from the video signal.

The Advanced Television Enhancement Forum (ATVEF) has defined protocols for Hypertext Markup Language (HTML)-based enhanced TV. These protocols allow the delivery of enhanced TV programs to STBs and other devices providing interactive functionality by various transmission means, including, but not limited to, analog, digital, cable, and satellite. For the NTSC format, ATVEF specifies the type of information that may be inserted into the VBI of the video signal and on which lines of the VBI that information may be inserted. ATVEF specifies line 21 of the VBI as the line for insertion of an “ATVEF trigger,” i.e. the information that the STB or other device with interactive functionality interprets to provide interactive features to the enhanced TV program. ATVEF-A triggers comprise a Universal Resource Locator (URL), which provides an Internet address from which interactive content may be downloaded, whereas ATVEF-B triggers themselves can contain interactive content.

ITV technologies as well as increasing utilization of HDTV will certainly increase bandwidth requirements, which further corresponds to an increased cost to TV service providers. The increases in cost will result in a decrease in profit to TV service providers and/or an increase in costs to customers. It would be advantageous for TV service providers to be able to reduce their bandwidth requirements for certain broadcasts and ITV applications such that costs can be controlled without sacrificing quality of service.

### SUMMARY

The present invention is directed to solving these and other problems and disadvantages of the prior art. In accordance with certain embodiments of the present invention, a method for optimizing bandwidth utilization while broadcasting signals is provided. Specifically, the method comprises the steps of:

determining that a broadcast signal will be displayed in at least two portions on a display apparatus;

treating a first of the at least two portions in a first manner;

treating a second of the at least two portions in a second manner that differs from the first manner; and

transmitting a combination of the first and second portions as part of a single broadcast signal.

In accordance with one embodiment of the present invention treating the portions in different manners includes individually and independently adjusting the resolution associated with each portion. In other words, the amount of data required to display each portion is adjusted for each portion individually. The adjustment may be based upon the amount of space that the portion will occupy in the display apparatus and/or the type of data that is being displayed in the portion.

In accordance with another embodiment of the present invention, each portion may be processed individually based upon characteristics of that portion. For instance, the first portion may include video data, whereas the second portion may include computer rendered images such as alphanumeric data, symbols, and other object that are displayed with hard edges. The video data may be compressed using a lossy compression algorithm since some video data loss is generally allowable and still results in good picture quality. On the other hand, the computer rendered images with hard edges may lose their picture quality if too much data is lost due to a compression algorithm. Therefore, the second portion may not be compressed at all, or may only be compressed with a lossless compression algorithm.

In accordance with another embodiment of the present invention, the amount of bandwidth required to transmit a given portion may be determined by the amount of display space that each portion will require. As an example, if the portion will be displayed on ¼ of the display apparatus, then the amount of bandwidth usually required to transmit a full screen version of the portion may be reduced by the same amount. In an alternative embodiment, this fraction may represent the maximum amount of data that is removed from the portion and the actual amount of data removed may be further based on the type of data that is being displayed. For instance, a video portion occupying ¼ of the display apparatus may have its resolution decreased to ¼ of its original resolution, whereas a computer rendered image occupying the same fraction of the display apparatus may only have its resolution decreased to ⅓or ½ of its original resolution.

Decreasing the resolution or amount of data associated with displaying a given portion will result in a lower bandwidth requirement to transmit the same portion. In the past, when a broadcast was decreased in size and presented on only a portion of a display apparatus, the same amount of bandwidth was required to transmit that broadcast even when it was presented on only a portion of the display apparatus. Therefore, further network bandwidth was required to present information in addition to the broadcast. For example, additional bandwidth is required to display a broadcast along with a pay-per-view or channel selection guide menu. The required network bandwidth is increased by the amount of bandwidth required to transmit the additional content. However, embodiments of the present invention recognize that a lower resolution may utilized to display the same broadcast at the same picture quality that was previously provided in full screen when the broadcast is being presented on only a portion of the display apparatus. Hence, in accordance with embodiments of the present invention, when it is determined that the full screen broadcast will only be displayed on a portion of the screen, the resolution of the broadcast is decreased thereby freeing up network bandwidth for the transmission and display of the additional content.

The content that is displayed along with the broadcast or similar type of video footage may include interactive TV content, such as interactive advertisements (IADs), interactive applications (e.g., gaming applications, polling applications, channel selection menus, pay-per-view menus, etc.), programming statistics, important announcements, and the like. In one embodiment, the broadcast head end may determine that a broadcast will be displayed on a portion of the screen and will therefore determine that the resolution of the broadcast should be reduced. In another embodiment, the broadcast head end may receive notification from a display apparatus or STB associated with a display apparatus indicating that the user has switched the display of the broadcast to only occupy a portion of the display apparatus. In response to receiving such a notification, the broadcast head end may then begin reducing the resolution of the broadcast to save network bandwidth utilization.

Reducing network bandwidth utilization may not only free up network bandwidth for a given channel, but may also free up network bandwidth for use by other channels. The reduction of bandwidth requirements for a number of channels will ease bandwidth requirements for a TV service provider, which in turn will result in lower operating costs. Additionally, reductions in bandwidth requirements on a per-channel basis can also reduce network congestion, which may result in better network performance and quality of service.

In accordance with at least some embodiments of the present invention, the bandwidth utilization on a per channel basis may also be reduced to allow a single channel the ability to offer multiple video and/or interactive services on a single channel. It is thus one aspect of the present invention to utilize a single channel to broadcast graphics/video content and text/data content separately. A STB, tuned to the appropriate channel, may then determine that the channel comprises simultaneously, but separately, transmitted video and data content. Upon tuning to such a channel, the STB may render the video and data content separately then simultaneously display both contents to the user. In other words, the STB may be adapted to recognize a chunk of video data and a chunk of actual data then cause the video data to be displayed in a first portion of the display apparatus and the actual data to be displayed in a second portion of the display apparatus. Accordingly, a channel can be used to transmit and present two, three, four, or more video services simultaneously on half, one third, one fourth, or smaller fractions of the display apparatus.

In accordance with another embodiment, a device for optimizing TV broadcast bandwidth utilization is provided. The device generally comprises the following:

an input for receiving a datastream containing input image representative pixel data;

a separation agent operable to determine that pixel data associated with a first portion of the datastream will be displayed on a first portion of a display apparatus and pixel data associated with a second portion of the datastream will be displayed on a second portion of the display apparatus, wherein the separation agent is further operable to separate the pixel data into the corresponding first and second portions;

a processor for independently applying a first treatment algorithm to the first portion of pixel data and a second treatment algorithm to the second portion of pixel data thereby altering both the first and second portions of pixel data; and

an output for transmitting a datastream containing output image representative pixel data, wherein pixel data associated with the output image comprises the altered first and second portions of pixel data.

As used herein “content” includes any type of user-perceptible substance that can incorporate visual and/or audio media. Content is typically in the form of video media or static pages that can be viewed on a TV or the like by a user. Examples of content include, but are not limited to, a live broadcast that may be received from a satellite provider, a cable provider, or over free air, advertisements or information for certain products and/or services, recorded images, computer rendered images or other graphics, audio content, and so on.

The summary is not intended to provide an exhaustive description of all embodiments of the present invention. Namely, additional features and advantages of embodiments of the present invention will become more readily apparent from the following description, particularly when taken together with the accompanying drawings.

### BRIEF DESCRIPTION OF THE DRAWINGS

FIG. 1 is a block diagram depicting a TV broadcast system in accordance with embodiments of the present invention;

FIG. 2 is a block diagram depicting a STB in accordance with embodiments of the present invention;

FIG. 3 is a screen shot depicting a full screen view of a TV broadcast in accordance with embodiments of the present invention;

FIG. 4 is a screen shot depicting a split screen view of a TV broadcast in accordance with embodiments of the present invention;

FIG. 5 is a flow chart depicting a method of optimizing network bandwidth utilization while broadcasting a TV signal in accordance with embodiments of the present invention;

FIG. 6 is a flow chart depicting a method of preparing a broadcast signal for transmission across a network in accordance with embodiments of the present invention;

FIG. 7 is a flow chart depicting a method of receiving a broadcast signal and preparing it for display in accordance with embodiments of the present invention;

FIG. 8 is a flow chart depicting a method of calculating resolution requirements based on display size in accordance with embodiments of the present invention; and

FIG. 9 is a flow chart depicting a method of using a single channel to offer and present multiple video and/or interactive services in accordance with embodiments of the present invention.

### DETAILED DESCRIPTION

Embodiments of the present invention are generally directed toward methods and systems for optimizing network bandwidth requirements when transmitting TV signals. Although well suited for use with a television or similar type of display apparatus in conjunction with a STB, those skilled in the art can appreciated that embodiments of the present invention may also be implemented in conjunction with a simple television set not including a STB. Moreover, the systems and methods described in the present disclosure may be implemented in any media that presents user perceptible data by transmitting such data across a network.

As used herein “viewer” and “user” are used synonymously to refer to any person or thing that is currently making use of and/or interacting with the television system.

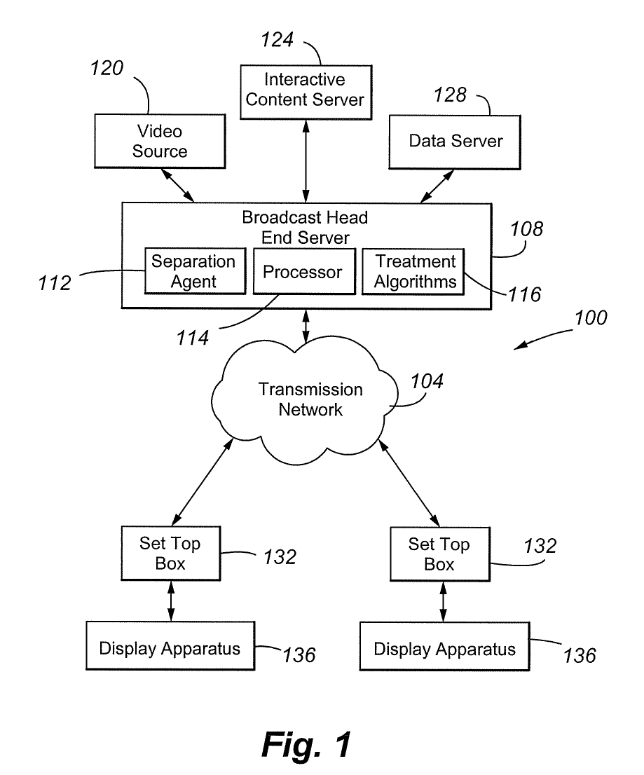

Referring now to FIG. 1, one embodiment of a broadcast system 100 will be described in accordance with embodiments of the present invention. The broadcast system 100 may comprise a transmission network 104, a broadcast head end server 108 including a separation agent 112, a processor 114, and treatment algorithms 116, a video source 120, an interactive content server 124, a data server 128, a plurality of set top boxes (STBs) 132, and a plurality of display apparatuses 136. Each STB 132 and display apparatus 136 may generally comprise a TV system and although each display apparatus 136 is depicted with a corresponding STB 132, the display apparatus 136 may be directly connected to the transmission network 104, thereby obviating the need for a STB 132.

In accordance with one embodiment of the present invention, the transmission network is characterized by a number of signal carrying and relaying devices. The transmission network 104 may comprise an over-air transmission network where a terrestrial transmitter transmits TV signals. Alternatively, or in addition, the transmission network 104 may comprise a satellite transmission network employing terrestrial based and satellite based signal transmitters. In a satellite transmission network, signals may be initially transmitted by a base terrestrial transmitter and may be relayed by satellites orbiting in the Earth's atmosphere to satellite receivers associated with users of the network 104. In such an embodiment, the satellite receiver is connected to the STB 132 which decodes the signal received at the satellite receiver. Another type of transmission network 104 that may be employed is a cable network. A cable network is may comprise an extensive network of cables (e.g., coaxial, fiber optic, etc.) that are used to carry signals from the broadcast head end server 108 to each network user. Any other type of known transmission network 104 may be employed in accordance with embodiments of the present invention.

The broadcast head end server 108, in accordance with one embodiment of the present invention, is characterized by the ability to process image and audio signals for transmission across the transmission network 104. The broadcast head end server 108 may comprise a single server or a number of servers (i.e., a server pool) each having capabilities of the broadcast head end server 108 described herein. The term “server” as used herein should be understood to any type of dedicated processing resource such as a media server, a broadcast server, computers, adjuncts, etc.

The broadcast head end server 108 is connected to a number of media sources. A first media source may include a video source 120. The video source 120 may comprise a video camera or a server used to transmit video images. The video source 120 may further include and provide a sound input to the broadcast head end server 108. The video source 120 generally supplies broadcast content, such as content usually transmitted during a TV broadcast. Although a single video source 120 is depicted, one of skill in the art will appreciate that a number of video sources 120 may be connected to the broadcast head end server 108. One or a number of video sources 120 may be associated a different TV network and the broadcast head end server 108 provides a common transmission point for all networks.

A second media source may include an interactive content server 124. The interactive content server 124 may be used to provide interactive content in the form of long or short form advertisements, interactive applications, or other information to a user of the display apparatus 136. In one embodiment, the interactive content server 124 provides a trigger along with a broadcast, which if engaged by the user, will begin to allow the user to use the interactive content. The user may be allowed to navigate through the interactive content via the use of additional triggers. Some of the interactive content may be stored at the interactive content server 124 and supplied to the user upon request. Alternatively, or in addition, some of the interactive content may be uploaded to the user's STB 132 such that it can be retrieved locally when the user desires to engage with the interactive content.

A third media source that may provide data to the broadcast head end server 108 may include a data server 128. The data server 128 may work in conjunction with the video source 120 and/or the interactive content server 124 to provide raw data for display. Alternatively, the data server 128 may provide raw data directly to the broadcast head end server 108 where it is combined with another data source prior to being transmitted across the network 104. As an example, the data server 128 may be associated with an emergency broadcast system whereby when an emergency alert needs to be displayed to a certain population of users, the data server 128 provides the emergency information to the broadcast head end server 108. The broadcast head end server 108 may then overlay the emergency information on a TV broadcast such that both are displayed simultaneously.

In accordance with at least some embodiments of the present invention, content associated with two or more of the media sources (e.g., video source 120, interactive content server 124, and data server 128) may be displayed simultaneously on the display apparatus 136. The content from each media source may be combined at the broadcast head end 108 prior to transmission across the network 104. The broadcast head end server 108 may determine that an image associated with one media source may be displayed on a first portion of the display apparatus 136 while an image associated with another media source may be displayed on a second portion of the display apparatus 136.

In accordance with embodiments of the present invention, the processor 114 may utilize the separation agent 112 to identify the different media sources and therefore different images in a combined broadcast signal. The processor 114 may then apply different treatment algorithms 116 on each different media source. By applying a different treatment algorithm 116 on each different media source, the processor 114 independently processes each image differently.

The processor 114 may be implemented as a microprocessor or similar type of processing chip. The processor 114 may complete executable instructions or routines stored in a portion of memory associated with the broadcast head end server 108. Alternatively, the processor 114 may be implemented in the form of an application specific integrated circuit (ASIC) that is operable to perform predefined functions based on predetermined inputs. The processor 114 generally functions to run programming code including operating system software, and one or more applications implementing various functions performed by the broadcast head end server 108.

In accordance with one embodiment of the present invention, the treatment algorithms 116 may comprise a number of different image processing algorithms. Examples of the treatment algorithms 116 include, but are not limited to, image compression algorithms (e.g., MPEG), image resolution adjustment algorithms, formatting algorithms, and the like. The type of treatment algorithm 116 chosen for a given image may depend upon the type of image or images within the media source. For example, a lossy compression algorithm may be utilized in the event that the media source is the video source and the image will be a moving video image. Alternatively, a lossless compression algorithm may be utilized in the event that the media source is the raw data from the data server 128 or computer rendered images from the interactive content server 124.

As can be appreciated by one of skill in the art, the separation agent 112, treatment algorithms 116, and processor 114 may be maintained in a distributed fashion. In other words, the application of treatment algorithms 116 may be applied on a channel by channel basis, where a network associated with each channel determines whether the image resolution can be reduced because the image size will be reduced on the eventual display of the channel. For example, a channel such as Bloomberg TV may determine that full resolution is not required for a particular video image while stock prices are being scrolled across other portions of the screen. In this example, the video image resolution may be reduced by Bloomberg prior to providing the channel to the broadcast head end server 108 which would then only need to act as a re-transmission engine for the channel to the display apparatuses 136. Alternatively, a dedicated channel continuously employing embodiments of the present invention may be provided.

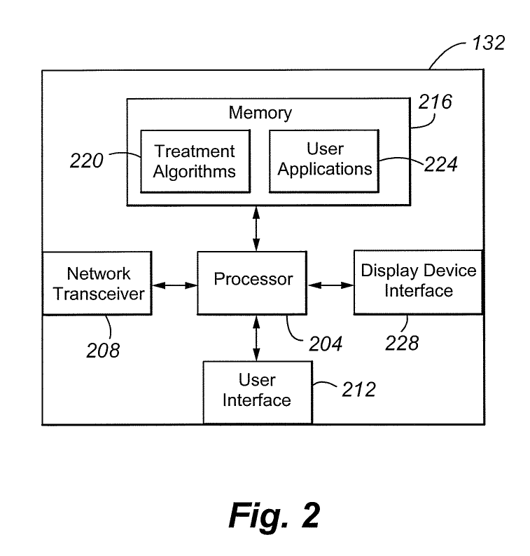

With reference now to FIG. 2, a STB 132 will be described in accordance with at least some embodiments of the present invention. The STB 132 may comprise a processor 204, a network transceiver 208, user interface 212, a memory 216 including treatment algorithms 220 and user applications 224, and a display apparatus interface 228.

The processor 204 may be implemented as a microprocessor or similar type of processing chip. The processor 204 may complete executable instructions or routines stored in a portion of memory 216. Alternatively, the processor 204 may be implemented in the form of an application specific integrated circuit (ASIC) that is operable to perform predefined functions based on predetermined inputs. The processor 204 generally functions to run programming code including operating system software, and one or more applications implementing various functions performed by the STB 132.

The memory 216 may be implemented as a volatile or non-volatile memory, or combinations thereof. For example, the memory 216 may comprise a temporary or long-term storage of data or processor instructions. The memory 216 may be used in connection with the presentation of image information such as a video or the like to a viewer. The memory may also be used in connection with implementing an interactive application for presentation on the display apparatus 136. The memory 216 may comprise solid-state memory resident, removable or remote in nature, such as DRAM, SDRAM, ROM, and EEPROM.

The memory 216 may contain treatment algorithms 220 for processing data received at the network transceiver 208. The treatment algorithms 220 may include treatment algorithms comparable to the treatment algorithms 116 maintained at the broadcast head end server 108. For example, the treatment algorithms 220 may comprise decompression algorithms corresponding to compression algorithms associated with the treatment algorithms 116. The treatment algorithms 116 are generally used to prepare a signal for transmission across the transmission network 104 whereas the treatment algorithms 220 are generally used to undo the results of the treatment algorithms 116 and prepare the images for display on the display apparatus 136.

The memory 216 may also include a number of user applications 224. The user applications 224 may be associated with interactive applications or the like. Storage of user applications 224 on the memory 216 allow for execution of interactive applications locally rather requiring transmission from the interactive content server 124.

In another embodiment, the execution of the application 224 may occur at the broadcasting head end server 108. Accordingly, control signals may be transmitted from the STB 132 to the broadcast head end server 108 and results of the execution of the application may be transmitted to the STB 132 from the broadcast head end server 108.

The user interface 212 may comprise a receiver for communicating with a user control device such as a conventional wired or wireless TV remote control, a universal remote control, or the like. The user interface 212 may include an infrared (IR) receiver for receiving signals from an IR controller. The user interface 212 may also comprise a keyboard, mouse, or other type of direct user input. A user may employ a remote control device to interact with interactive content and/or to navigate other types of content presented to the user.

The display device interface 228 provides the STB 132 the ability to communicate with the display apparatus 136. The display device interface 228 may include wired or wireless communication equipment. For example, the display device interface 228 may comprise a USB port or video jack. Alternatively, the display device interface 228 may comprise an RF transceiver for transmitting/receiving RF signals to/from the display apparatus 136.

The STB 132 is operable to communicate with the broadcast head end server 108 via the network transceiver 208. The network transceiver 208 may comprise a coaxial cable connection, a USB port or other type of serial port, a modem, an Ethernet adapter, a satellite adapter, or the like. Content received at the network transceiver 208 is communicated to the processor 204 and/or the memory 216. Content that may be transmitted to the STB 132 includes, but is not limited to, live broadcasts from cable, satellite, or radio waves, songs, application data, application results, recorded video and static images, computer rendered images, specialized advertisements, triggers, and the like. The transceiver 208 may also be used to transmit data to the broadcast head end server 108.

Typically, user applications 224, computer rendered images, and specialized advertisements are stored in the memory 216 when they are received at the network transceiver 208. The content is typically stored in a particular address of the memory such that it can be easily retrieved at a later time. In normal operation, content or user application 224 updates are sent to the STB 132 during idle periods (i.e., when the user is not viewing a live broadcast). However, content can also be sent to the STB 132 during a live broadcast through one or more VBIs as packets of information that can be stored in memory 216 while the live broadcast is being displayed. The packets of information can then be stored in memory 216 (e.g., a buffer memory) and reconstructed by the processor 204.

As noted above, the user applications 224 may include interactive applications and/or interactive advertisements that are access by a trigger. A trigger usually contains an address, pointer, or some other sort of reference to the stored content or a live broadcast. When a user activates a trigger during a broadcast, the processor 204 uses the address of stored content associated with the trigger to retrieve the content from memory 216 or from the broadcast head end server 108. In the event that the content associated with the trigger is a live broadcast, then the trigger references the channel where the live broadcast can be found. Subsequently, the content can be displayed to a user via the display apparatus 136. Thus, multiple pre-stored contents can be maintained in the memory 216 for later display at the appropriate time or a user can navigate multiple live contents via triggers.

Generally, a trigger is transmitted along with a broadcast and both are displayed to a user via the display apparatus 136. A user is able to select the displayed trigger via the user interface 212. The processor 204 registers the request, determines the address of the stored content in memory 216, and retrieves the associated content from the memory 216. Alternatively, the processor 204 registers the request and determines the address of the live broadcast content on another channel. Thereafter, the requested content is transmitted to the display apparatus 136 for presentation to the user.

Selection of a trigger may also indicate that the content displayed on the display apparatus 136 is to be altered. In other words, engagement of a trigger may indicate that the display is to be altered to incorporate at least two different images. The two different images may include a broadcast, interactive content, channel selection guides, pay-per-view menus, or any other images or set of images.

A trigger can be transmitted with a broadcast, a live advertisement, and/or an interactive advertisement (e.g., a short form or long form advertisement). The trigger is used to begin interaction with the user applications 224 stored in memory 216 and/or on the broadcast head end server 108.

In accordance with at least some embodiments of the present invention, content associated with the trigger may be live content on a different channel. The trigger presented to the user may include a question asking the user if he/she would like to change channels. When the trigger is actuated, a portion of the display apparatus 136 is changed from the original channel to the new channel associated with the trigger. Furthermore, the original channel may continue to be displayed to the user in a smaller portion of the display apparatus 136, thereby resulting the simultaneous display of two images. Of course, other mechanisms may be employed to initiate the display of two or more images at the same time on the display apparatus 136. As an example, a user may select an on-screen channel selection guide, which is displayed concurrently with the broadcast.

When a decision is made to display an image or set of images on less than the full size of the display apparatus 136, the STB 132 may transmit a message to the broadcast head end server 108 signifying that the images being transmitted for display on the display apparatus 136 will ultimately be displayed at less than full size. The broadcast head end server 108 may then begin processing the images differently in order to conserve network bandwidth utilization. For example, the broadcast head end server 108 may reduce the amount of pixel data representing each image being broadcast to the display apparatus 136 since the image will not need as high a resolution (due to the decreased area it will occupy).

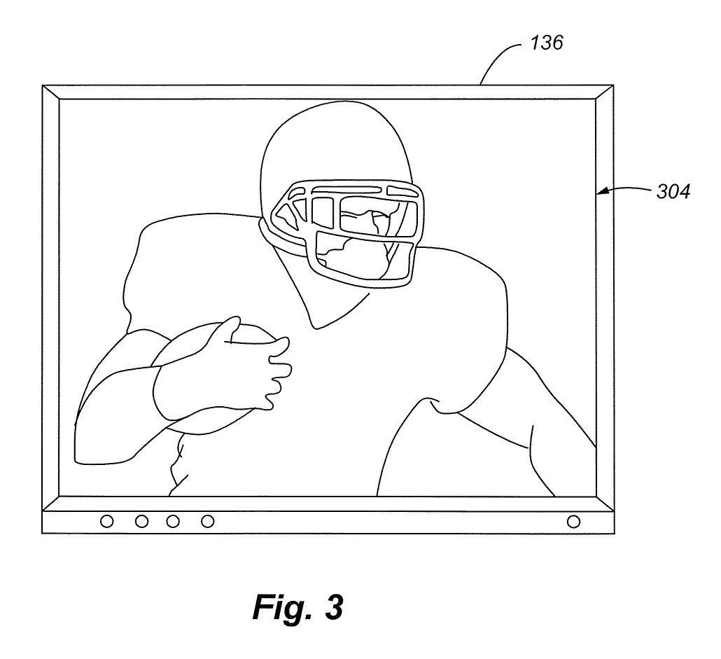

FIG. 3 depicts a full screen image 304 being displayed on a display apparatus 136. The full screen image 304 comprises pixel data that is used to display the full screen image 304. The full screen image 304 may comprise a greater or lesser amount of pixel data depending upon the resolution of the image capturing equipment as well as the data transmission equipment. Currently, the amount of resolution commercially available on a display apparatus 136 ranges from about 640×480 to about 1920×1080, although greater amounts of resolution may be envisioned within the scope of the present invention. The clarity with which a full screen image 304 is displayed on the display apparatus 136 depends upon the size and number of the pixel frames of the display apparatus 136 as well as the resolution of the transmitted signal. If the display apparatus 136 only comprises enough pixels to support a 1280×720 resolution image but the transmitted signal only comprises enough pixels to support a 704×480 resolution image, then the resolution of the image will be limited to the lower amount of resolution (i.e., 704×480).

The number of pixels or pixel data associated with a given image depends upon the resolution of the image as well as the frequency with which the image is refreshed (i.e., interlaced versus progressively scanned images). Table 1 depicts a number of pixels that are typically associated with a given image resolution.

TABLE 1
Resolution vs. Pixel/frame

| Resolution | Pixels/frame |
|---|---|
| 480p | 338,000 |
| 720p | 922,000 |
| 1080i | 1,037,000 |
| 1080p | 2,074,000 |

As can be seen above, a 1080p HD resolution image represents about twice the amount of resolution information or data as a standard 1080i HD resolution image. Furthermore, the 1080p HD resolution image contains about six times the information (i.e., pixel data) as the 480p resolution image. It follows that about six times as much bandwidth is required to transmit the 1080p image data versus the 480p image data. If a full screen image 304 is to be displayed, then more pixel data will ultimately mean a better picture. However, when the image initially represented by the full screen image 304 is to be reduced in size such that only a portion of the image will be displayed, a large portion of resolution data is still transmitted although it does not make a significant difference in image quality.

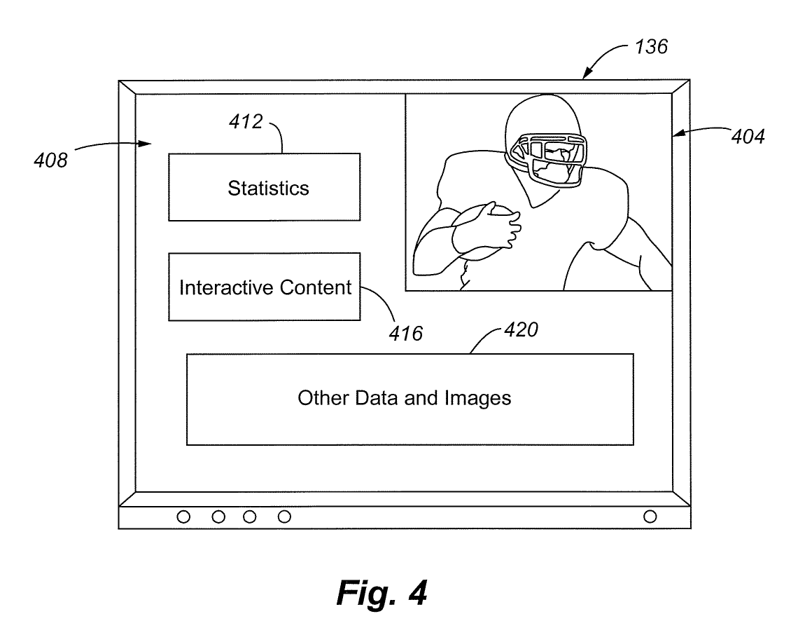

FIG. 4 depicts a partial or split screen view of a number of images on a display apparatus 136 in accordance with at least some embodiments of the present invention. As can be appreciated by one of skill in the art, a lesser amount of pixel data is required to present the first portion of the image 404 as compared to the full screen image 304 while still maintaining the same image quality.

In accordance with embodiments of the present invention, when a user decides to divide the display of the display apparatus 136 such that multiple images are simultaneously displayed, the images presented on less than the full screen will probably not require as much pixel data to provide an image of comparable quality to a full screen image 304. The display apparatus 136 may be partitioned into at least a first portion 404 and a second portion 408. Of course, there is no limit to the number of portions that the display apparatus 136 may be divided into. The number of pixels that exist on the display apparatus 136 may provide an upper limit to the number of images that can be simultaneously displayed on the display apparatus 136.

The types of images that may be presented on the display apparatus 136 may include, but are not limited to, video images such as the broadcast video images displayed on the first portion 404, computer rendered images that provide statistics or raw data 412 possibly in the form of alphanumeric symbols, interactive content images 416, and other data and images 420. The statistics images 412 may be supplied to the broadcast head end server 108 via the data server 128. The interactive content 416 may be provided to the broadcast head end server 108 from the interactive content server 124. The amount of pixel data associated with a given image may vary depending upon the amount of space occupied on the display apparatus 136 by the image. For example, since the image in the first portion 404 of the display apparatus 136 is occupying about ¼ of the total area of the display apparatus 136, the amount of pixel data associated with that image may be reduced by up to ¼ of the full screen image 304 pixel data. Of course, a reduction in bandwidth utilization by reducing pixel data for an image should be weighed against the quality of image that is desired. Accordingly, the pixel data of the image in the first portion 404 may be reduced by only about ½ of the original pixel data of the full screen image 304 in an attempt to optimize the balance between bandwidth utilization and image quality.

Another factor that may be considered when determining how much pixel data should be reduced is the type of the image that is being displayed. For instance, a video image in general can afford to lose a certain amount of pixel data whereas computer rendered images may not be able to lose the same amount of pixel data due to their hard edges and the like. Furthermore, a broadcast of fast moving images such as a sporting event may require a different amount of pixel data to supply the same quality image on the same size of the display apparatus 136 as a broadcast of slower moving images. Therefore, the amount of pixel data reduction may vary depending upon not only the ultimate display size of the image but the type of the image or even the nature of the content.

As can be appreciated by one of skill in the art, the amount of bandwidth required to transmit a given broadcast signal may also be affected by the frequency and manner in which the image is transmitted and thereby created on the display apparatus 136. As an example, an interlaced image transmits every other line of the image whereas a progressively scanned image transmits an image progressively without skipping lines. Transmission of interlaced images is typically accomplished at 60 Hz whereas progressively scanned images are transmitted at or around 30 Hz. Even though a progressively scanned image is transmitted at a lower frequency, a greater amount of network bandwidth is required to transmit a progressively scanned image as compared to an interlaced image. The reason for this is a great amount of data is transmitted with each progressively scanned image in comparison to the interlaced image. The result is a higher resolution image with a progressive scan transmission. In accordance with one embodiment of the present invention, when it is determined that an image will displayed on less than the entire display apparatus 136, the image resolution may be adjusted by switching from a progressively scanned image to an interlaced image.

Alternatively, or in addition, the frequency of transmission may be adjusted in order to conserve network bandwidth. For example, a progressively scanned 1080 image (i.e., an image with 1920×1080 resolution) may be transmitted at either 30 Hz or 24 Hz. The difference in frequency is somewhat minimal but still may impact the amount of network bandwidth required to transmit the image. Accordingly, when an image is to be displayed on a portion of the display apparatus 136, the image transmission rate may adjust from 30 Hz to 24 Hz in an attempt to conserve network bandwidth utilization. The change in image transmission rate may be accomplished by omitting the transmission of a certain number of images every certain number of cycles. For instance, every tenth image out of one hundred may deleted in order to reduce bandwidth utilization.

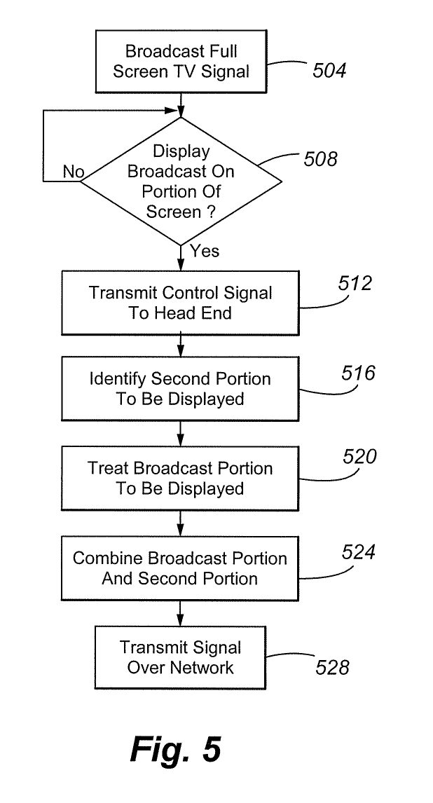

FIG. 5 depicts a method of optimizing network bandwidth utilization while broadcasting a TV signal in accordance with at least some embodiments of the present invention. Initially, an image is broadcast from the broadcast head end 108 to the display apparatus 136 for display as a full screen image 304 or set of images (step 504). The broadcast signal may comprise video images and/or computer rendered images associated with a conventional TV broadcast. The broadcast signal may also comprise an audio signal to accompany the image or images that are transmitted across the network 104. Thereafter, it is determined whether the images associated with the broadcast signal are to be displayed on less than all (i.e., a portion) of the display apparatus 136 (step 508). This determination may be affirmed by a user engaging a trigger associated with interactive content. Alternatively, the user may select another type of channel selection menu, pay-per-view menu, or other available display option (e.g., picture-in-picture) and thereby provide an indication that the broadcast is to be displayed on a portion of the display apparatus 136.

If the broadcast signal is to continue to be displayed as a full screen image 304, then the method continues to wait at step 508. On the other hand, if the broadcast signal is to be displayed on a portion of the display apparatus 136, then a control signal is transmitted from the STB 108 to the broadcast head end server 108 (step 512). The control signal may be transmitted in connection with a trigger typically associated with interactive content. The control signal may also be transmitted as a stand-alone signal indicating that the display of the broadcast signal is to be reduced in size.

Upon receiving the control signal, the broadcast head end server 108 identifies the image or images that are to be displayed concurrently with the broadcast signal (i.e., the first image) (step 516). In the event that the control signal was received in connection with a trigger, the trigger may identify the address of the location of the application or image to be displayed in the second portion of the display apparatus 136. The control signal may also identify another broadcast channel that is to be displayed in the second portion 408. As can be appreciated, more than images may be displayed simultaneously and for that reason the display apparatus 136 may be divided into more than first 404 and second 408 portions.

The control signal may also indicate that the second image to be displayed in the second portion 408 of the display apparatus 136 is maintained locally in association with the display apparatus 136. For instance, the content may be stored in memory 216 of the STB 132 or may be provided to the display apparatus 136 from another local source such as a video game console, DVD player, video tape player, or other type of hard disk drive or reader. In this particular embodiment, the control signal may only indicate that the first image will be displayed at smaller than full size and will not identify the location of the second image.

In still another embodiment of the present invention, the control signal may simply be a request to change channels to a channel that transmits video images as well as computer rendered images. An example of such a channel may include Bloomberg TV, CNN Head Line News, ESPN News, and the like. These particular channels fill a portion of the display apparatus 136 with the video images while the rest of the display apparatus 136 displays information such as stock prices, futures prices, headlines, and statistics. These particular channels may always have video images transmitted in connection with other data.

After the broadcast head end server 108 has identified the location of the image to be displayed in the second portion 408, the broadcast head end server 108 utilizes the separation agent 112 to treat the broadcast portion separate from the second portion (step 520). In other words, the broadcast head end server 108 may apply a first set of treatment algorithms 116 to a first portion (e.g., the broadcast portion being received from the video source 120), while applying a second different set of treatment algorithms 116 to a second portion (e.g., image content received from the interactive content server 124 or the data server 128). In the event that the images are stored locally in association with the display apparatus 136, the broadcast head end server 108 may simply treat the first portion with the first set of treatment algorithms 116 in preparation for display of the images on the first portion 404 of the display apparatus 136.

In accordance with embodiments of the present invention, the treatment of each portion or image separately may include reducing the amount of pixel data associated with the broadcast signal without changing the amount of pixel data associated with other images to be displayed on the display apparatus 136. The reduction in the amount of pixel data associated with a given image will reduce the amount of bandwidth required to transmit the image across the network 104 at the expense of image resolution. However, since the image size is being reduced in comparison to a full screen image, the image quality will not substantially change due to the decrease in image resolution. Treatment of each portion or image separately may also include applying one compression algorithm to a first image while applying a second different algorithm to a second image or not applying any compression algorithm to the second image.

When all images have been processed, the images may be combined into a single signal for transmission across the transmission network 104 and ultimate display on the display apparatus 136. Once combined, the signal may be transmitted over the transmission network 104 to the appropriate display apparatus 136 or to all display apparatuses 136 connected to the transmission network 104.

In one embodiment, a particular channel (i.e., Bloomberg, CNN, ESPN, etc.) may be broadcast to all viewers with the video images treated in a first manner while the computer rendered images are treated in a second different manner. The reduction to the resolution of video images for a channel may be performed when the channel determines that the video image size will be reduced, instead of receiving a control signal from the STB 132. The reduction to resolution may be provided for transmission to all display apparatuses 136. Having a channel control the decision to reduce the resolution of a video image for transmission to all display apparatuses 136 will greatly reduce the amount of network bandwidth required for the channel.

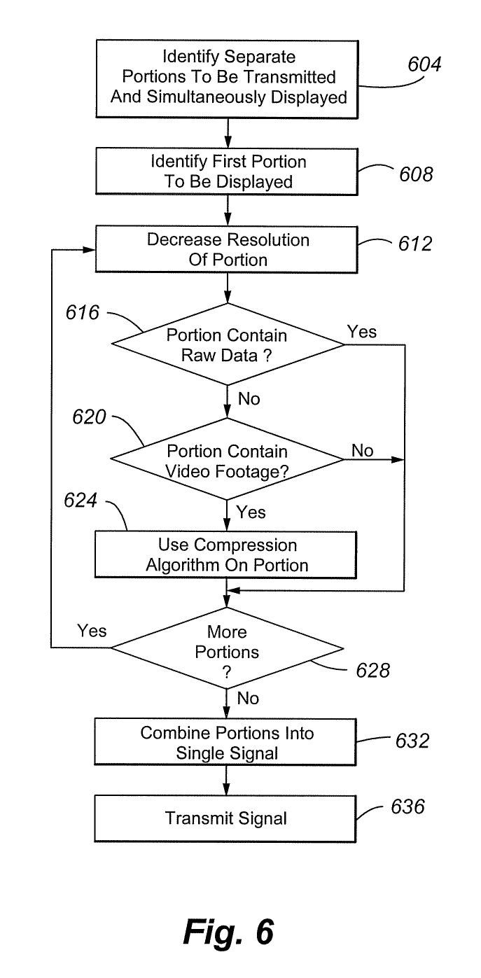

FIG. 6 depicts a method of preparing a broadcast signal for transmission across a network 104 in accordance with at least some embodiments of the present invention. The method begins when each of the portions to be simultaneously displayed are identified by the processor 114 (step 604). Thereafter, the processor 114 identifies the first portion to be displayed (step 608). In this step, the processor 114 identifies the pixel data associated with the first portion that will ultimately represent the image presented in the first portion of the display apparatus 136.

After the pixel data of the first portion has been identified, the processor 114 may employ a treatment algorithm 116 to decrease the resolution of the subject portion (step 612). Eliminating some pixel data or averaging a number of pixel data points into a single pixel data point may accomplish the reduction of resolution. Other resolution reduction techniques may include decreasing the refresh rate and therefore the transmission rate of the images across the transmission network 104. The reduction in resolution of the image may depend upon the type of image as well as the content of the image. One type of image may have its resolution decreased by a first amount whereas other types of images may have their respective resolution decreased by a second different amount or not at all.

Once the resolution of the subject portion has had its resolution decreased, the processor 114 determines whether the portion contains raw data or any other image, which may contain hard edges (e.g., computer rendered images) (step 616). If the image does not contain any raw data or other hard-edged images, then the method continues to determine whether the image contains video footage or a set of image (step 620). In other words, the processor 114 identifies whether the subject portion will be displaying a series of images such as those captured by a video recorder or camera, rather than a single still image.

If the portion will be used to display video images, then the processor 114 uses a compression algorithm on the subject portion (step 624). The compression algorithm for a video type image may include lossy compression algorithms. A lossy compression algorithm, such as MPEG, may be employed to compress the pixel data for each frame of video because video images allow for a certain amount of data loss without a large compromise to overall image quality. On the other hand, still images or computer rendered images cannot generally maintain image quality if pixel data is lost due to the use of a lossy compression algorithm. Accordingly, in the event that the subject portion contains hard-edged images or still images, the portion may not be compressed or may only be compressed by a lossless image compression algorithm.

After the subject portion has had its pixel data properly compressed, or it has been determined that the portion contains hard-edged or still images, then the processor 114 determines whether there are more portions or other images that make up the full screen presentation (step 628). If there are additional images that still require separate processing, then the method returns to step 612 for the next identified image. Otherwise, the method continues by combining all of the portions (i.e., all of the pixel data) into a single signal in preparation for transmission (step 632). After the portions have been successfully combined, the method continues by transmitting the signal (step 636).

As noted above, the independent processing of multiple images in a broadcast signal is typically performed at the broadcast head end server 108. However, in alternative embodiments, the independent processing may be performed for an individual channel prior to providing the channel signal to the broadcast head end server 108.

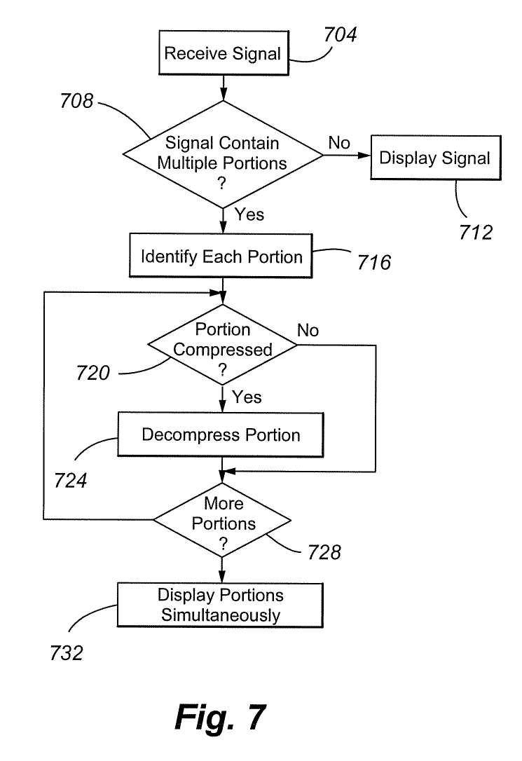

FIG. 7 is a flow chart depicting a method of receiving a broadcast signal and preparing it for display in accordance with at least some embodiments of the present invention. Initially, a broadcast signal is received from the transmission network 104 (step 704). The broadcast signal may be received at a STB 132 or directly at a display apparatus 136. Included in the receiving step, the broadcast signal may be decoded, in the event that the signal was encoded for transmission across the network 104.

Upon receiving the signal, it is determined whether the signal contains multiple portions (i.e., images) to be displayed simultaneously on the display apparatus 136 (step 708). If the STB 132 has previously transmitted a control signal to the broadcast head end server 108 indicating that the display of multiple images on the same display apparatus 136 was desired, then this query may be answered positively. Alternatively, the broadcast head end server 108 may include a flag or manipulate an indicator bit signifying that the broadcast contains multiple images to be displayed simultaneously. The processor 204 may then read the indicator bit and determine that the broadcast signal contains multiple images on a single frame.

If the broadcast does not contain multiple portions or images, then the broadcast signal is simply prepared for display to the user as a full screen image 304 (step 712). If, however, the broadcast signal does contain multiple images on a common frame, then each of the portions or images are identified (step 716). More specifically, the pixel data associated with each image is identified as corresponding to separate images. Separator indicators or bits may be employed to identify the beginning and end of the pixel data for each image.

Once the pixel data for each portion has been identified, the method continues by independently determining whether a subject portion of pixel data has been compressed (step 720). If the pixel data has not been compressed, then the method continues by determining if there are more portions of pixel data that may require independent processing (step 728). However, if the portion is determined to have had its pixel data compressed, then the method continues by properly decompressing the pixel data (step 724). The pixel data may be decompressed through utilization of a decompression algorithm from the treatment algorithms 220. The decompression algorithm used should correspond to the compression algorithm used by the broadcast head end server 108 such that errors are not introduced to the pixel data by improper decompression. Therefore, the broadcast head end server 108 may notify the STB 132 as to the type of compression algorithm employed to compress a certain portion of pixel data.

After the pixel data has been properly decompressed, the method continues by determining if there are more portions in the broadcast signal that correspond to discrete images (step 728). If there are more portions, then the method returns to step 720. Once all portions of the broadcast signal have been properly processed, the frame (i.e., all pixel data) is displayed on the displayed on the display apparatus 136 (step 732). In this step, each of the images is displayed on the display apparatus on their respective portions of the display apparatus. The total amount of pixel data represented by all of the images may be comparable (i.e., equal) to or slightly greater than the total amount of pixel data represented by a single full size image displayed on the display apparatus 136 in accordance with one embodiment of the present invention. Alternatively, the resolution of each image may be reduced such that the total amount of pixel data represented by all of the images in the frame may be less than the total amount of pixel data represented by a single full size image.

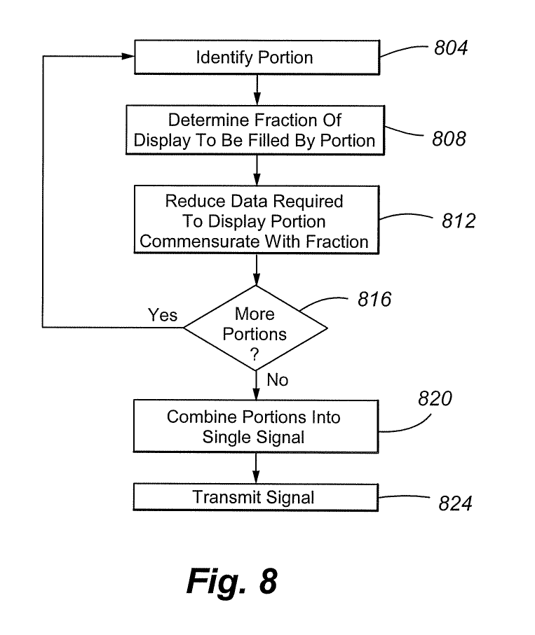

FIG. 8 depicts a method of calculating resolution requirements based on display size in accordance with at least some embodiments of the present invention. The method begins when a portion of a broadcast is identified as having a separate image that is to be displayed on a portion of the display apparatus 136 (step 804). After a portion and its corresponding pixel data has been identified, the method continues by determining the fraction of the display apparatus 136 that will be filled by the image associated with the subject portion (step 808). This determination may be made by comparing the amount of pixel data associated with the subject portion with the total amount of pixel data. Alternatively, the fraction of the display assigned to an image may be predetermined. The fraction of the display apparatus 136 occupied by the subject image may range from a very small fraction of the display to a very large fraction of the display. The lower range of the fraction of the display apparatus 136 occupied by an image may be around 1/100 of the total display apparatus 136 image presentation area, while the upper limit may be very close to the entire image presentation area.

When the fraction of the display apparatus 136 to be occupied by the subject portion has been determined, the method continues by reducing the data associated with the image commensurate with the fraction (step 812). In this step, the resolution of the image is reduced based on the fraction. In one embodiment, the resolution (i.e., the pixel data) is reduced by the exact amount of the fraction. In an alternative embodiment, the resolution is reduced in proportion to the fraction. For example, the resolution may be determined to be reduced by half the fraction or by twice as much as the fraction. The amount by which the resolution is reduced may vary greatly depending upon the type of image and the nature of the content depicted by the image. As can be appreciated, the resolution of the image displayed by the subject portion may also be reduced by other mechanisms such as varying the refresh rate associated with the creation of the image or by eliminating a certain number of images for a given amount of cycles.

The fraction may also be used as a threshold that identifies when transmission rates should be altered or to determine when pixel data should be reduced. As an example, a number of fractional thresholds may exist, each corresponding to a certain reduction is image resolution. When a first fraction threshold is passed, the image resolution may be reduced by a first amount. When a second fractional threshold is passed, the image resolution may be reduced by a second amount, and so on. This may provide a step-wise or discrete resolution reduction algorithm that is more easily implemented than other resolution reduction algorithms.

After the resolution of the subject portion has been reduced, the method continues by determining if more portions exist within the same frame (step 816). If more portions do exist, then the method returns to step 804. Otherwise, the method continues by combining all of the portions pixel data into a single signal for transmission across the network 104 (step 820). Thereafter, the signal is transmitted across the network 104 to one or more of the display apparatuses 136 connected to the network 104 (step 824).

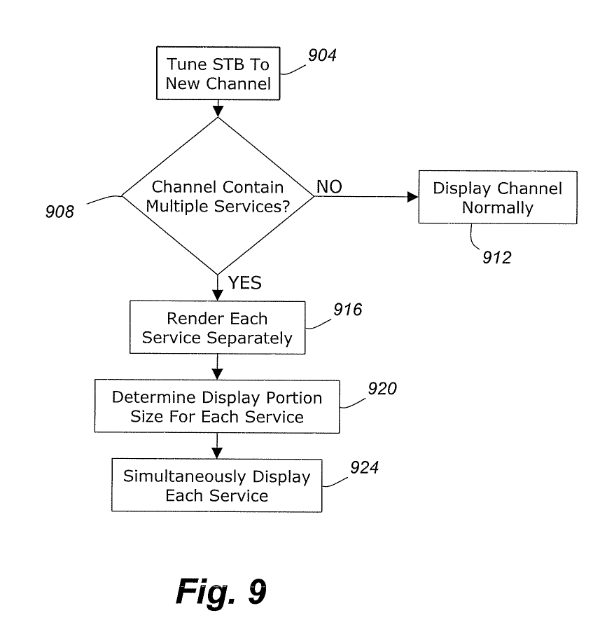

With reference now to FIG. 9, a method of processing and displaying a single channel that offers and presents multiple video and/or interactive services will be described in accordance with at least some embodiments of the present invention. The method is initiated when a STB 132 is tuned to a new channel (step 904). Tuning to a new channel may comprise the STB 132 switching to a different frequency that has a dedicated amount of bandwidth on the transmission network 104. Traditional channels are used to transmit a single service over that allocated bandwidth. However, in accordance with at least some embodiments of the present invention, a single channel may be used to transmit multiple services. Accordingly, when the STB 132 is tuned to a new channel, the STB 132 determines whether the new channel contains multiple services (step 908).

As used herein, “services” may be understood to include content that is capable of populating a traditional channel such as a video/audio datastream. Services may include video/audio datastreams, raw datastreams, interactive datastreams, and the like.

In the event that the channel corresponds to a traditional channel and does not contain multiple services, the STB 132 continues by displaying the datastream associated with the channel in the normal fashion (step 912).

On the other hand, if the channel is determined to have multiple services, the STB 132 renders each service separately (step 916). The ability to transmit multiple services over a single channel may be achieved by reducing the amount of bandwidth that each service requires. More specifically, the pixel resolution of any image/video data associated with a service may be reduced, thereby reducing the amount of bandwidth required to transmit the image/video datastream. The STB 132 renders each service separately, because each service may comprise different types of data and each service may require a different type of decompression or use of a different decompression algorithm.

After the STB 132 has separately rendered each service, the respective services are ready for independent display. However, the STB 132 first must prepare the services for simultaneous display with each of the other services. To accomplish this task, the STB 132 determines the display portion size that will be allocated to each service (step 920). In accordance with certain embodiments of the present invention, the STB 132 may count the number of services and divide the display equally among the services. Accordingly, if there are four services being transmitted over the same channel, then the STB 132 will allocate a quarter screen display to each service. Alternatively, if one service has a priority over other services, then it may be afforded a larger portion of the display. In accordance with some embodiments of the present invention, the STB 132 may allocate portions to the services based on the amount of money that has been paid for each service. If a service has purchased more display size, then that particular service may be allocated a larger portion of the display.

Once the STB 132 has determined the display portion size for each service, the STB 132 causes each of the services to be displayed simultaneously on a common display apparatus 136 (step 924). In this step, a user is provided with a plurality of services, which may include a number of video, interactive, and other services, by tuning into a single channel.

While the above-described flowcharts have been discussed in relation to a particular sequence of events, it should be appreciated that changes to this sequence can occur without materially effecting the operation of the invention. Additionally, the exact sequence of events need not occur as set forth in the exemplary embodiments. The exemplary techniques illustrated herein are not limited to the specifically illustrated embodiments but can also be utilized with the other exemplary embodiments and each described feature is individually and separately claimable.

The systems, methods and protocols of this invention can be implemented on a special purpose computer in addition to or in place of the described STB, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a communications device, such as a phone, any comparable means, or the like. In general, any device capable of implementing a state machine that is in turn capable of implementing the methodology illustrated herein can be used to implement the various communication methods, protocols and techniques according to this invention.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer and television arts.

Moreover, the disclosed methods may be readily implemented in software that can be stored on a storage medium, executed on a programmed general-purpose computer with the cooperation of a controller and memory, a special purpose computer, a microprocessor, or the like. In these instances, the systems and methods of this invention can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications device or system.

It is therefore apparent that there has been provided, in accordance with the present invention, systems and methods for bandwidth optimization. While this invention has been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this invention.

What is claimed is:

1. A method of optimizing bandwidth utilization in a broadcast system, comprising:
determining that a broadcast signal will be displayed in at least two portions on a display apparatus;
treating a first of the at least two portions in a first manner;
treating a second of the at least two portions in a second manner that differs from the first manner; and
transmitting a combination of the first and second portions as part of a single broadcast signal.

2. The method of claim 1, further comprising:
determining that the first portion display size will be smaller than a full size of the display apparatus;
decreasing resolution of the first portion;
transmitting the first portion at the decreased resolution; and
displaying the first portion at the decreased resolution while the first portion is displayed at less than the full size of the display apparatus.

3. The method of claim 2, further comprising:
determining a fraction of the display apparatus that will display the first portion; and
decreasing the resolution of the first portion based on the determined fraction such that a lesser amount of data is maintained in association with the first portion as compared to the first portion at full resolution.

4. The method of claim 1, wherein data associated with the second portion is transmitted during Vertical Blanking Intervals (VBIs) of the broadcast signal and wherein data associated with the first portion is transmitted during non-VBIs.

5. The method of claim 1, wherein determining that the broadcast signal will be displayed in at least two portions on a display device comprises determining that a user of the display apparatus desires to engage with interactive content via the display apparatus.

6. The method of claim 5, further comprising transmitting a control signal from a Set Top Box (STB) associated with the display apparatus to a broadcast head end, wherein the control signal indicates that interactive content is desired.

7. The method of claim 1, wherein treating the first portion in a first manner comprises compressing the first portion and wherein treating the second portion in a second manner comprises failing to compress the second portion.

8. The method of claim 7, wherein the first portion is associated with video data and wherein the second portion is associated with computer rendered images.

9. The method of claim 7, further comprising:
receiving the single broadcast signal;
decompressing the first portion; and
simultaneously displaying the first and second portions on the display apparatus.

10. The method of claim 10, wherein the compression and decompression steps comprise employing a video compression algorithm.

11. The method of claim 1, wherein treating the first portion in a first manner comprises compressing the first portion using a lossy data compression algorithm and wherein treating the second portion in a second manner comprises compressing the second portion using a lossless data compression algorithm.

12. The method of claim 1, wherein treating the first portion in a first manner comprises reducing the amount of data associated with displaying the first portion by a first amount.

13. The method of claim 12, wherein treating the second portion in a second manner comprises reducing the amount of data associated with displaying the second portion by a second amount.

14. The method of claim 13, wherein the first and second amounts depend upon the fraction of the display apparatus that each respective portion will occupy.

15. A computer readable medium comprising processor executable instructions for performing the method of claim 1.

16. A device for use in broadcasting television (TV) signals, comprising:
an input for receiving a datastream containing input image representative pixel data;
a separation agent operable to determine that pixel data associated with a first portion of the datastream will be displayed on a first portion of a display apparatus and pixel data associated with a second portion of the datastream will be displayed on a second portion of the display apparatus, wherein the separation agent is further operable to separate the pixel data into the corresponding first and second portions;
a processor for independently applying a first treatment algorithm to the first portion of pixel data and a second treatment algorithm to the second portion of pixel data thereby altering both the first and second portions of pixel data; and
an output for transmitting a datastream containing output image representative pixel data, wherein pixel data associated with the output image comprises the altered first and second portions of pixel data.

17. The device of claim 16, wherein the processor is further operable to determine that the first portion of the datastream display size will be smaller than a full size of the display apparatus and wherein the processor employs a treatment algorithm comprising instructions for decreasing resolution of the first portion of the datastream as compared to a resolution of the first portion of the datastream prior to being altered.

18. The device of claim 16, wherein the first treatment algorithm comprises reducing the amount of pixel data associated with the first portion of the datastream.

19. The device of claim 18, wherein the second treatment algorithm comprises reducing the amount of pixel data associated with the second portion of the datastream by an amount that differs from the reduction of pixel data associated with the first portion of the datastream.

20. The device of claim 18, wherein the processor reduces the amount of pixel data associated with the first portion of the datastream based on a proportion of the display apparatus that will be used to display the first portion of the datastream.

21. The device of claim 16, wherein the output is further operable to receive a control message from a set top box (STB) associated with a display apparatus, and wherein the control messages indicates that the first portion of the datastream will be displayed on a fraction of the display apparatus.

22. The device of claim 21, wherein the control message is associated with a trigger indicating a request for interactive content.

23. The device of claim 16, wherein the first treatment algorithm comprises a lossy compression algorithm.

24. The device of claim 23, wherein the second treatment algorithm comprises a lossless compression algorithm.

25. A device for receiving broadcast television (TV) signals, comprising:
an input for receiving a datastream containing input image representative pixel data;
a processor for independently applying a first treatment algorithm to a first portion of the datastream and a second treatment algorithm to a second portion of the datastream thereby altering the pixel data of each portion differently; and
an output for transmitting the datastream comprising the first and second portions such that the pixel data associated with the first and second portions are simultaneously displayed.

26. The device of claim 25, wherein the datastream comprises video data and computer rendered images.

27. The device of claim 26, wherein the first portion comprises the video data and the second portion comprises the computer rendered images.

28. The device of claim 25, wherein the first portion is associated with broadcast content and the second portion is associated with interactive content.

29. The device of claim 25, wherein the first treatment algorithm comprises a lossy decompression algorithm.

30. The device of claim 29, wherein the second treatment algorithm comprises a lossless decompression algorithm.

31. A method of optimizing bandwidth utilization in a broadcast system, comprising:
dividing a full screen display into a number of portions;
associating a fraction with each of the number of portions, wherein the fraction associated with a portion is based on the size of the portion compared to the full screen display;
receiving a first datastream containing image representative pixel data;
identifying the member of portions that will display the pixel data associated with the first datastream; and
adjusting the pixel data of the first datastream based on the number of portions that will display the pixel data associated with the first datastream.

32. The method of claim 31, wherein the pixel data associated with the first datastream will be displayed on less than all of the portions of the full screen and wherein the pixel data of the first datastream is reduced.

33. The method of claim 32, wherein the pixel data is reduced by an amount based on the number of portions that will display the pixel data associated with the first datastream and the fraction associated with each portion.

34. The method of claim 31, further comprising:
receiving a second datastream containing image representative pixel data;
identifying the number of portion that will display the pixel data associated with the second datastream;
adjusting the pixel data of the second datastream based on the number of portion that will display the pixel data associated with the second datastream; and
simultaneously displaying the pixel data associated with the first and second datastreams.

35. A method, comprising:
tuning to a single television channel that has been broadcast across a transmission network;
determining that the channel contains two or more services;
independently rendering each of the two or more services for display; and
causing each of the two or more services to be displayed substantially simultaneously on a common display apparatus.

36. The method of claim 35, wherein the two or more services comprise a first service and a second service and wherein content associated with the first service is different from content associated with the second service.

37. The method of claim 36, wherein the first service comprises a video service and wherein the second service comprises an interactive service.

38. The method of claim 36, wherein the first service comprises at least one of a video and interactive service and wherein the second service comprises raw data.

39. The method of claim 35, wherein the two or more services comprise at least two interactive services.

40. The method of claim 35, wherein at least one of the two or more services has a reduced amount of pixel data as compared to pixel data of the at least one service prior to transmission of the at least one service.
